(19) United States
(12) Patent Application Publication
(10) Pub. No.: US 2014/0141821 A1
(43) Pub. Date: May 22, 2014

(54) Method and Devices to Convey Session Participant List to a Store and Forward Group Chat Recipient

(71) Applicant: Infinite Convergence Solutions, Inc., Arlington Heights, IL (US)

(72) Inventors: Geoffrey Dietz, Hoffman Estates, IL (US); Susan Urbina, Ingleside, IL (US)

(21) Appl. No.: 14/079,241

(22) Filed: Nov. 13, 2013

Related U.S. Application Data
(60) Provisional application No. 61/727,643, filed on Nov. 16, 2012.

(51) Int. Cl. H04W 4/12; H04L 12/58

(52) U.S. Cl. CPC H04W 4/12; H04L 51/28
USPC 455/466; 709/206

(57) ABSTRACT

This invention provides a telecommunications server apparatus and related wireless messaging client apparatus to transmit a group message with an accurate group recipient list to store and forward group message recipients.

### CROSS-REFERENCE TO RELATED APPLICATIONS

This application claims the benefit of U.S. provisional patent application No. 61/727,643 also titled “Method and Devices to Convey Session Participant List to a Store and Forward Group Chat Recipient” filed by the present inventors on Nov. 16, 2012.

### FEDERALLY SPONSORED RESEARCH

None.

### SEQUENCE LISTING

None.

### FIELD OF THE INVENTION

This pertains to telecommunications message servers, telecommunications messaging clients including mobile devices and wireless tablets, and provides a method to convey an accurate list of group chat recipients to those messaging clients which are temporarily unavailable.

### BACKGROUND OF THE INVENTION

Currently the telecommunications standards such as Rich Communication Suite including RCS-e and RCS-5.x and other standards define Store and Forward messaging for recipients of 1-to-1 chat sessions. RCS 5.1 further provides a store and forward notification method for group recipients which are powered off or otherwise not available during the chat session. However, as defined by current industry standards the store and forward solution is not ideal for group chat as not all information about the group is given to the unavailable recipient when the recipient becomes available. Typically recipients in a session are notified as participants join or leave the session and messaging during the session does not contain an actual recipient list for the message, as everyone currently in the session receives the message. Group chat recipients which may be powered-off or otherwise unavailable at the time of the chat therefore as they do not know who was involved in the group and who else received the same message. The present inventors have solved this problem.

### SUMMARY OF INVENTION

The described method and telecommunications message server and telecommunication clients provide an accurate list of group chat participants to a store and forward group chat messages in an ad-hoc or predefined group scenario with the complete list of group participants supplied with each message. Note that either the list of group participants at the beginning of the chat session, or the list of recipients for each message (accounting for members that may have left the group) may be sent to the store and forward group chat recipient.

### GLOSSARY

200 Ok Standard response after successful request
ACK Acknowledgement that the SIP handshake is complete and a session will be setup (the third step of SIP “three way handshake.”)
3GPP Third Generation Partnership Project
CPIM Common Presence and Instant Messaging as described in IETF RFC 3862
DIAMETER DIAMETER Base Protocol as described in IETF RFC 3588
IETF Internet Engineering Task Force
IMDN Instant Message Disposition Notification (e.g. a “read reply” or a display notification)
INVITE a SIP Message that indicates a client is being invited to participate in a session (the first step of SIP “three way handshake”)
MDN Mobile Device Number
Mobile A mobile device that supports the group chat client as modified for the current invention.
MSRP Message Session Relay Protocol
MSRP 200 OK MSRP successful acknowledgement message
SIP 200 Ok Standard response after successful SIP request (the second step of SIP “three way handshake.”)
PNR DIAMETER Protocol command “Push Notification Request”
RCS Rich Communication Suite
RCS-5 Rich Communication Suite version 5
RCS-e Rich Communication Suite version e, common in Europe.
RCS Store and Forward Server A particular Telecommunications Message Store and Forward Server
RFC Request for Comments document published by Internet Engineering Task Force
Sh Diameter protocol interface as described in 3GPP technical specifications 29.328 and 29.329.
SIP Session Initiation Protocol
S&F Store and Forward
X-CSCF Any of the I-CSCF (Interrogating—Call Session Control Function), P-CSCF (Proxy—Call Session Control Function) and S-CSCF (Serving—Call Session Control Function.

### BRIEF DESCRIPTION OF DRAWINGS

FIG. 1 shows delivery of a group chat message to a recipient, Mobile 2, that was unavailable at the time of the group chat session. Note that the other recipients of the group messages are sent to Mobile 2 as part of each message as seen in the MSRP SEND messages received from the Store and Forward server. It is possible for each message to have a slightly different list of group members as group members join or leave the chat session.

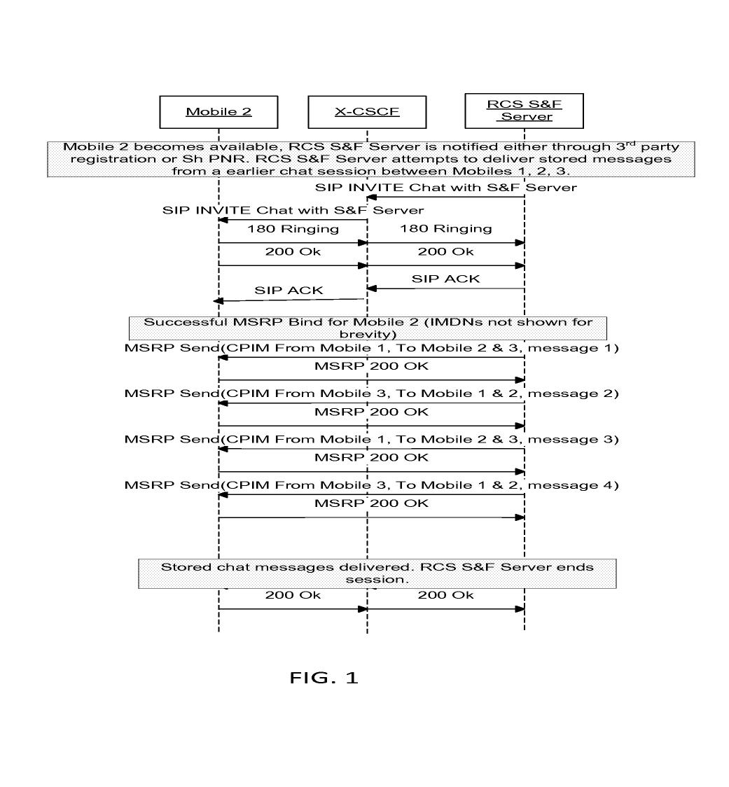

FIG. 2 shows a listing of a sample store and forward group message after it has been transformed by the telecommunications store and forward server. Note the lack of a group identifier in and the repeated use of the “To” header in the CPIM formatted message.

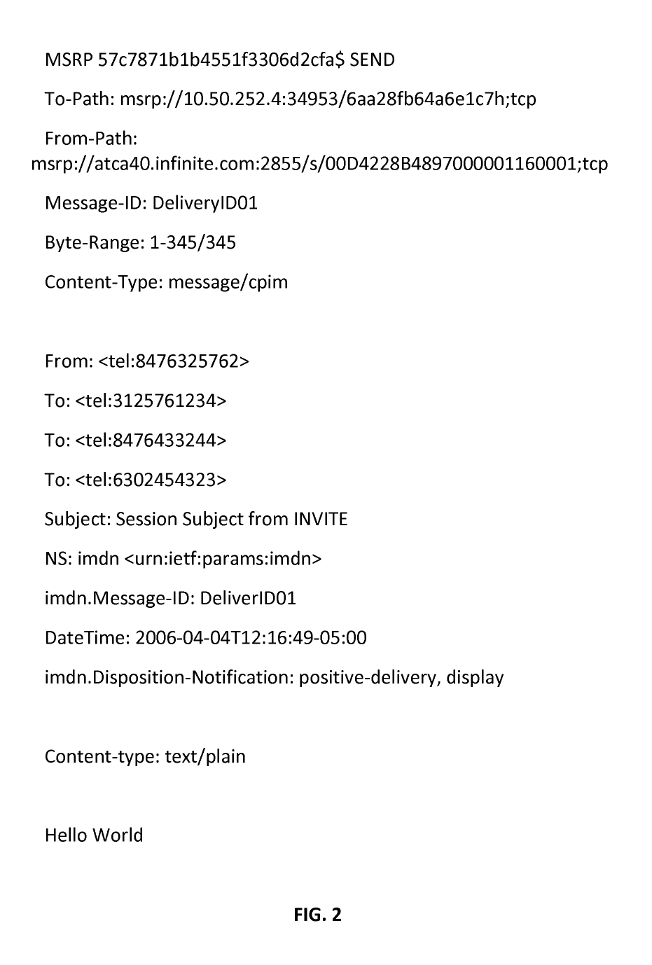

### DETAILED DESCRIPTION

For private chat messages the CPIM ‘To’ and ‘From’ header will contain the recipient's address (such as a MDN) and sender's address (MDN) respectively. Under the current art, for group chat scenarios the CPIM ‘From’ header is still the sender's address, such as MDN, but the CPIM ‘To’ header only contains an indication of the group, such as the group session identity. Specifically for adhoc groups the CPIM ‘To’ header may contain the IM Session Identity or <Session ID>@<Server Domain>. For Predefined groups the CPIM ‘To’ header contains the predefined Group ID (or short code).

In addition, during a group chat session the active participants may change over time as participants join or leave the group chat session. Typically, the current session participants are conveyed to all available participants using the SIP SUBSCRIBE/SIP NOTIFY operations. So, each client subscribed and available, will typically receive a SIP NOTIFY message each time a participant joins or leaves the chat session. However, SIP SUBSCRIBE/SIP NOTIFY are not supported in the telecommunications standards during a store and forward chat session used to deliver stored messages to an unavailable recipient client. It would also be complicated to use this method, since, once the client becomes available, the server will deliver all stored messages very quickly and the actual state of participants leaving and joining the session may not necessarily be recorded by the store and forward client recipient device.

The new method transforms the stored messages into private messages by recording the actual recipient list for each message directly in one or more CPIM ‘To’ headers as the messages are stored. For stored group messages, a telecommunications message server such a RCS Store and Forward Server will record the connected session participant addresses in the CPIM ‘To’ header similar to the format used for private group chat messages. For adhoc groups the CPIM ‘To’ header containing a list of one or more individual recipients replaces the IM Session Identity or <Session ID>@<Server Domain> used in adhoc groups. For Predefined groups the list of individual recipients in ‘To’ headers replace the CPIM ‘To’ header containing the predefined Group ID (or short code).

This method can also be used when a SIP INVITE starting a group chat session contains message payload. In this case the individual recipient list derived from the inbound group message is recorded with the message payload when the message is stored on the server for later delivery to the client.

The rule for when message storage will occur on the telecommunications server can be configurable with the possible options:

Option 1: Store messages for all participants, when none of the recipients are available initially when the group chat session is initiated. In this case the session would proceed, with all participants other than the session initiator in store and forward mode.

Option 2: Store messages for unavailable participants when one or more recipients are available for the initiated group chat session. In this case available participant including the chat session initiator and available recipients are invited to the chat session. Additional unavailable recipients are added to the session in store and forward mode.

Option 3: When a chat session participant drops from the session for a connection failure or other unexpected issues, the Server will convert the recipient to store and forward, while attempting to reestablish the session connection also. The session connection should be attempted for the remaining duration of the session. The store and forward attempts to deliver the stored message will continue after the session has been terminated

Option 4: The individual subscribers could have provisioning options for store and forward recorded in the presence server or subscriber database that control when store and forward will trigger for the individual when not available.

When the original group chat session is still active the Server attempts to connect the store and forward subscriber to the original session. If the connection is made during the session, any stored messages are forwarded to the recipient in order using that session (with the private messaging addresses in the CPIM ‘To’ headers, and original submission time stamps). Then the added participant can initiate new messages in the session as normal.

After the original session has ended, the Store and Forward Server will attempt to connect a store and forward session to the recipient with the stored messages. In this case the recipient list in the SIP INVITE will contain only the store and forward participant as the only chat session participant. In addition if SIP SUBSCRIBE is received for the session, the SIP NOTIFY will only indicate either the final participant list of the session or, alternately, indicate that only the one recipient is connected to the session. All stored messages are sent to the participant using the store and forward session which is a special session used to deliver store and forward messages to the previously disconnected recipient. A new session must be initiated if any new messages need to be sent. The CPIM ‘From’ header as normal conveys the original senders' address and the CPIM ‘To’ headers in this case conveys all the original recipients for the messages using the private addressing format. The Date and Timestamp of the message at submission to the server are conveyed as normal. The SIP INVITE used to setup the store and forward session can contain an optional text message in the SIP Subject header that indicates it is a stored session with a date and time stamp, and the initial list of participants. This text message provides basic information to the recipient allowing the recipient to determine if the session is of interest.

What we claim is:

1. A method to convey a list of group chat participants from a telecommunications message server to one or more messaging clients comprising: a telecommunications message server receiving a message addressed to a group; transformation of the group address to a list of individual recipients; recording the individual recipient list for each message; and transmitting the list of recipients to one or more messaging clients as part of a later forwarded message.

2. The method of claim 1 where the recipient list is stored in one or more CPIM ‘To’ headers included in part of the forwarded message.

3. The method of claim 1 where a SIP INVITE starting a group chat session contains message payload and the recipient list is recorded with the message payload when the message is stored.

4. A telecommunications message server which stores and forwards messages to temporarily unavailable clients while including an individual list of group chat participants for each message.

5. The telecommunications message server of claim 4 that uses one or more CPIM ‘To:’ headers to convey a list of individual recipients for each group message for later delivery.

6. A wireless message client which receives group messages as a private message containing a list of all other individual participants for each store and forward message.

7. The wireless message client apparatus of claim 6 that recognizes a message with multiple CPIM ‘To:’ headers to as a group message.

8. The wireless message client of claim 6 that recognizes an individual recipient list included as part of the SIP INVITE message as a group message.

9. The wireless message client of claim 6 that recognizes an individual recipient list included as a part of the MSRP SEND message as a group message.

10. The wireless message client of claim 6 that is included as part of a mobile phone.

11. The wireless message client of claim 6 that is included as part of a wireless tablet device.
